(19) United States
(12) Patent Application Publication
(10) Pub. No.: US 2006/0228201 A1
(43) Pub. Date: Oct. 12, 2006

(54) Mobile storage cart

(76) Inventor: Benjamin Lenceski, Calrks Summit, PA (US)

Correspondence Address: Lawrence P. Zale, Suite 201, 200 Abington Exec.. Park;, Clarks Summit, PA, 18411, US

(21) Appl. No.: 11/100,995

(22) Filed: Apr. 6, 2005

(51) Int. Cl. B60P 9/00

(52) U.S. Cl. 414/466; 414/462

(57) ABSTRACT

A portable cart is described which has an extendable base to elevate the cart to a proper height to mount in the receiver or a trailer hitch. The extendable base is retracted, pulling up the cart wheels. This allows the cart to be carried by a vehicle. Once at the desired location, the vehicle is parked. The extendable base is extended to support the weight of the cart, which is removed from the vehicle. The cart may then be lowered and wheeled to its use site. The cart may be designed to hold baseball equipment, act as a sports training cart with first aid supplies, or material spill cleanup equipment. It may also carry food and supplies for catering, contain an outdoor mobile grill, act as a service company cart, a construction cart, an equipment cart for first responders, a pet show cart, a trade show cart or employ armored to carry ammunition and military supplies.

### BACKGROUND OF THE INVENTION

1. Field of the Invention

The present invention relates to mobile storage carts, and more particularly to a mobile storage cart which is designed to be carried by a vehicle.

2. Discussion of Prior Art

Typically, there is a need to carry large amounts of equipment and supplies (“cargo”) to various events such as for baseball, football, soccer games, auto races, flea markets and festivals. Due to the large number of people at these events, parking may be a long distance from the actual location that the supplies, or equipment must be delivered.

Typically, one is required to:
a) unload the cargo from storage,
b) transport the cargo to a vehicle, such as an automobile, sport utility vehicle, truck or trailer, load the vehicle,
c) transport cargo in the vehicle to the nearest location where vehicles are allowed, typically a parking lot,
d) unload the cargo from the vehicle, and
e) transport the cargo from the parking lot to its intended target location, such as a baseball field, and use the equipment and supplies.

This process is then repeated in reverse order for the return trip after use. An average American family repeats this process for every child involved in sports, every weekend. This process can become very tedious over time.

Since many families now have vehicles with trailer hitches, trailers have been developed for carrying such cargo. These are not designed to be detached and pulled to the use site. Many of these are too large. If made smaller, many of these cannot be pulled at highway speeds. Also, driving a vehicle with a trailer requires some degree of expertise since they are difficult to drive, back up and turn around.

In an effort to carry cargo without the need for experience pulling a trailer, bumper carriers were designed. These are portable carts which fit into and are held by the receiver of a trailer hitch. These are typically a flat grating which supports various cargo. One disadvantage of the bumper carriers is that they require strapping to secure the cargo to the bumper carrier since they have no sides or top.

Another disadvantage is that they are not weatherproof and the cargo will become wet and dirty.

Another disadvantage is that the cargo on the bumper carrier should be removed and carried to the ultimate use site, and then be reloaded for the ride back home.

Another disadvantage of the bumper carrier is that it is difficult to lift and mount on a vehicle. It typically takes at least two individuals to lift, align and mount the bumper carrier.

Currently there is a need for a portable cart which can easily be delivered to a use site with a minimum of loading and unloading of the cargo.

### SUMMARY OF THE INVENTION

In accordance with the present invention, a portable cart designed for attachment to a vehicle having a trailer hitch with a receiver is disclosed. It employs a container having a mount side wall, an outer side wall, a front wall, a rear wall, roof and a floor. It is supported by at least two wheels. The cart has an extendable base connecting the wheels to the container and for supporting the container at a plurality of adjustable heights. A mount bar is connected to the portable cart designed to be received by said receiver of said vehicle's trailer hitch thereby supporting and carrying the portable cart.

The present invention may be embodied in a method of transporting cargo to a user site by providing a mobile cart having a container, wheels, and a mount bar, the cart being capable of being wheeled. The cart also has an extendable base capable of lifting the mount bar to a plurality of heights. A vehicle is provided for transporting the mobile cart, having a trailer hitch. The base is extended to allow the mount bar to be supported by the vehicle's trailer hitch. The mount bar is connected to trailer hitch of the vehicle. The extendable base is retracted so as to retract the wheels. The vehicle is driven to a desired user site thereby carrying the cart.

### OBJECTS OF THE INVENTION

An object of the present invention is to provide a portable cart that can be easily mounted and dismounted from a vehicle.

Another object of the present invention is to provide a portable cart that is a self contained unit.

Another object of the present invention is to provide a portable cart that is weather resistant.

Another object of the present invention is to provide a portable cart that can be carried by a vehicle, dismounted and wheeled to and from a use site.

Another object of the present invention is to provide a portable cart that is not required to be loaded and unloaded, but carries the cargo to its intended site of use.

Another object of the present invention is to provide a portable cart that also serves as storage at home.

Another object of the present invention is to provide a portable cart that may be locked, left outside to provide additional storage space.

Another object of the present invention is to provide a portable cart that will securely attach to a building wall when not in use.

### BRIEF DESCRIPTION OF THE DRAWINGS

A complete understanding of the present invention may be obtained by reference to the accompanying drawings, when considered in conjunction with the subsequent detailed description, in which:

FIG. 1 is an illustration of one embodiment of the present invention shown as it is being carried by a vehicle.

FIG. 2 is a perspective view of one embodiment of the present invention.

FIG. 3 is a perspective view of the embodiment of the present invention shown in FIG. 2 as viewed from the opposite side.

FIG. 4 is an illustration showing the extendable base of the present invention in its elevated position.

FIG. 5 is an illustration showing the extendable base of the present invention in its lowered position.

FIG. 6 is an illustration of a Sports Cart embodiment of the present invention intended for carrying and storing sports equipment:

FIG. 7 is an illustration of a Catering Cart embodiment of the present invention intended to be used for catering.

FIG. 8 is an illustration of a Materials Cleanup Cart embodiment of the present invention intended to be used to clean up materials spills.

FIG. 9 is an illustration of a Trainer's Cart embodiment of the present invention intended to be used by a sports trainer.

FIG. 10 is an illustration of an Outdoor Grill embodiment of the present invention.

FIG. 11 is an illustration of a First Response Cart and Hunting Cart embodiments of the present invention.

FIG. 12 is an illustration of a Pet Show Cart embodiment of the present invention.

FIG. 13 is an illustration of a Trade Show Cart embodiment of the present invention.

FIG. 14 is an illustration of devices which connect to the carts.

For purposes of brevity and clarity, like components and elements of the apparatus of this invention will bear the same designations or numbering throughout the figures.

### DESCRIPTION OF THE PREFERRED EMBODIMENT

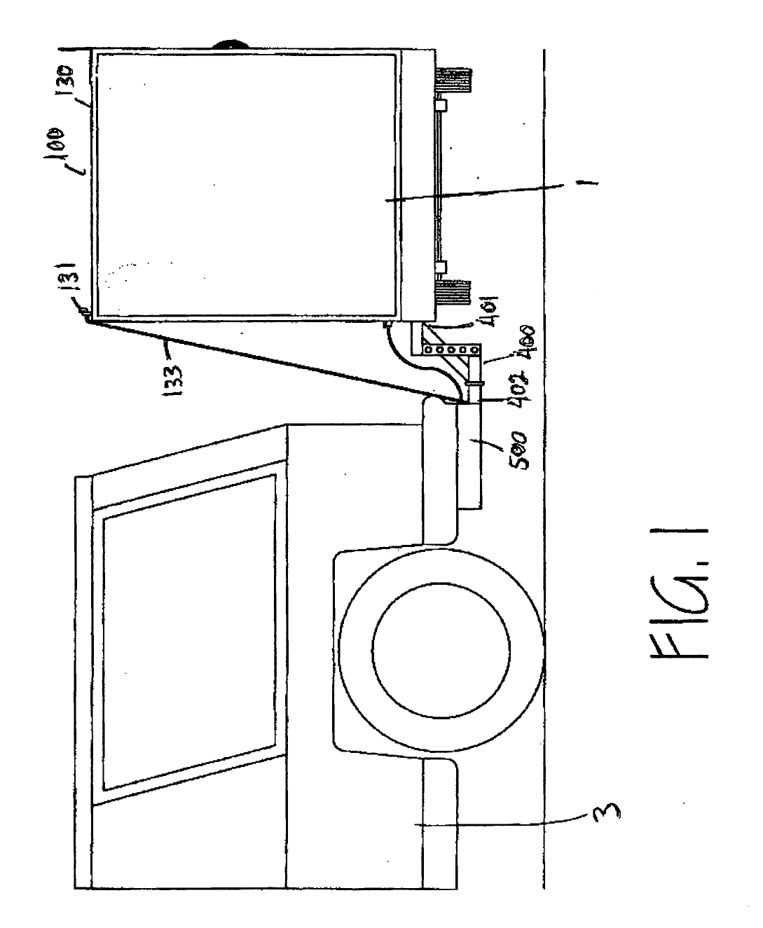

FIG. 1 is an illustration of one embodiment of the present invention shown as cart 1 attached to, and carried by a vehicle 3, such as a standard automobile, sport utility vehicle or truck. The present invention may also be modified in an alternative embodiment to be carried by heavier vehicles such as land moving equipment, commercial trucks and military vehicles.

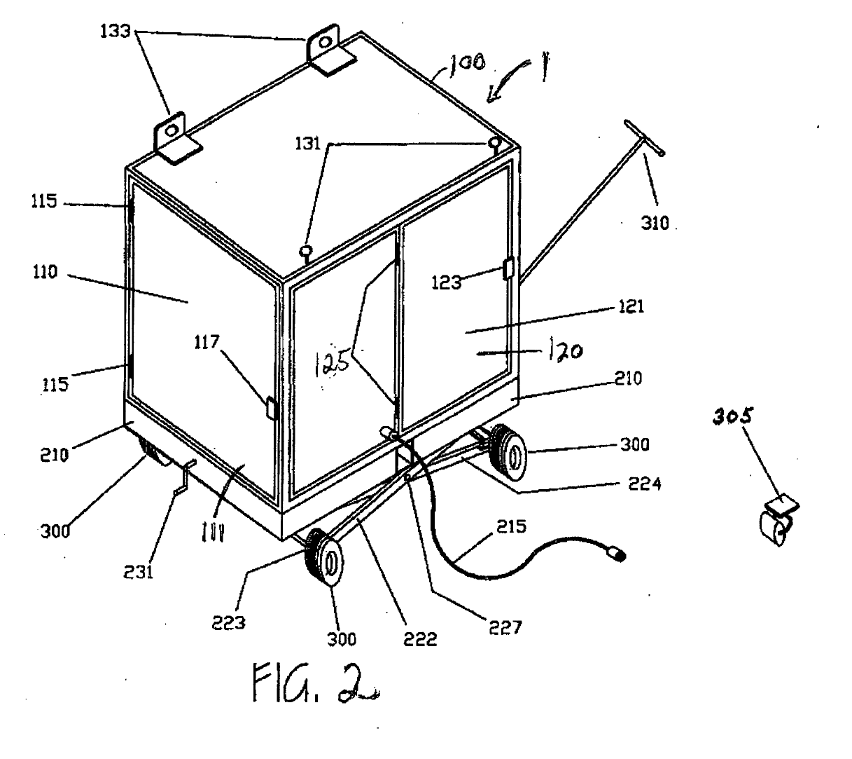

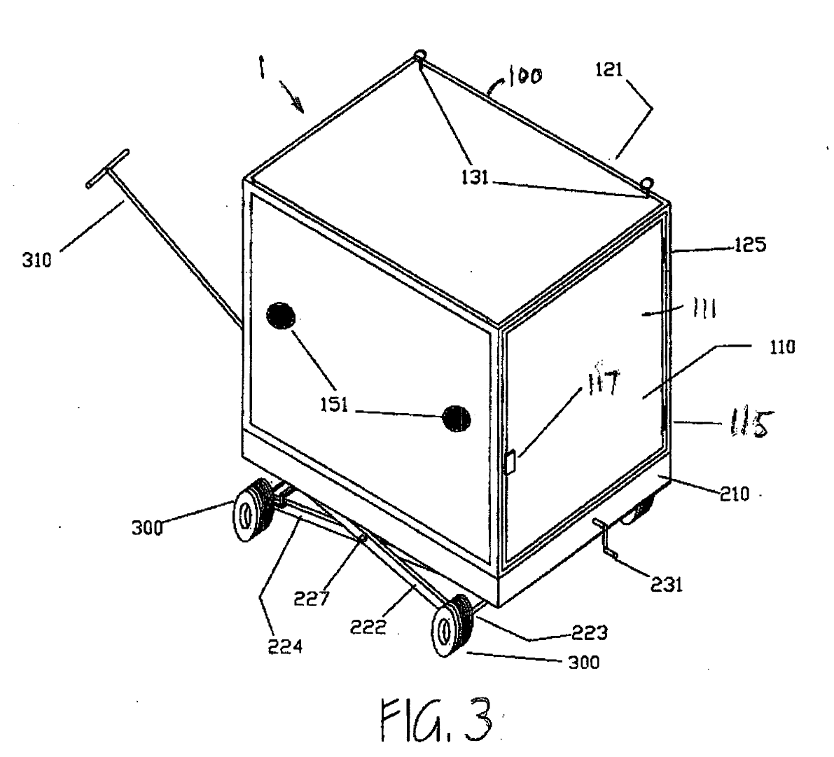

A cart 1 is shown as it would appear attached to a riser 400 and trailer hitch receiver 500 of vehicle 3 during travel. Cart 1 is intended to be unloaded from vehicle 3 at the vehicle's destination point, such as a parking lot, and pulled by a handle 310 on wheels 300 to its use location, such as a baseball field as shown in FIGS. 2 and 3. Handle 310 connects to a conventional steering system which steers wheels 300. Upon completion of its use, it is rolled back to its carrying vehicle and mounted again for travel.

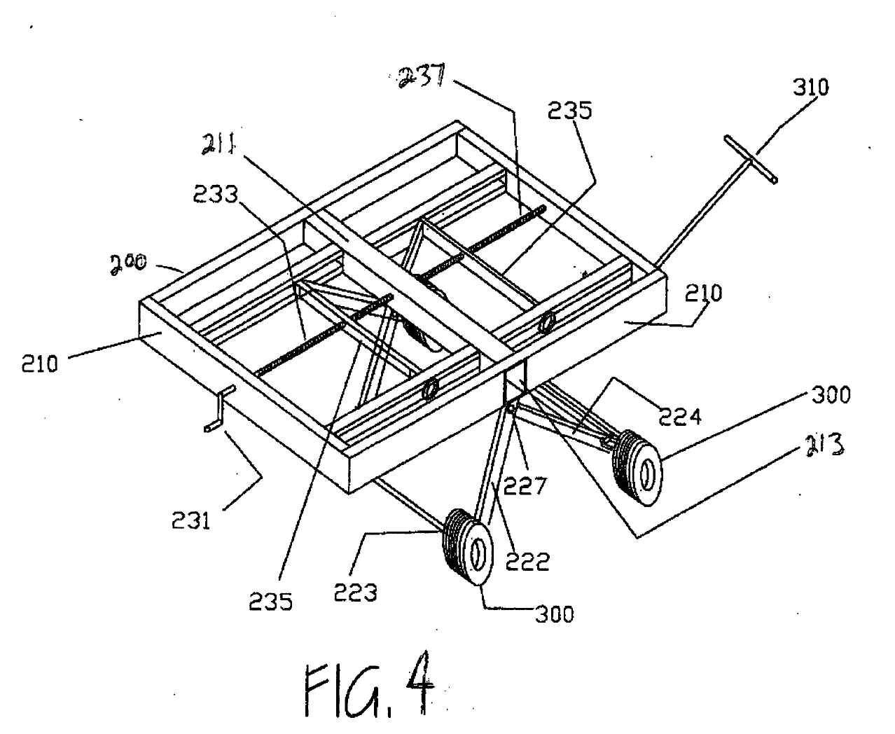

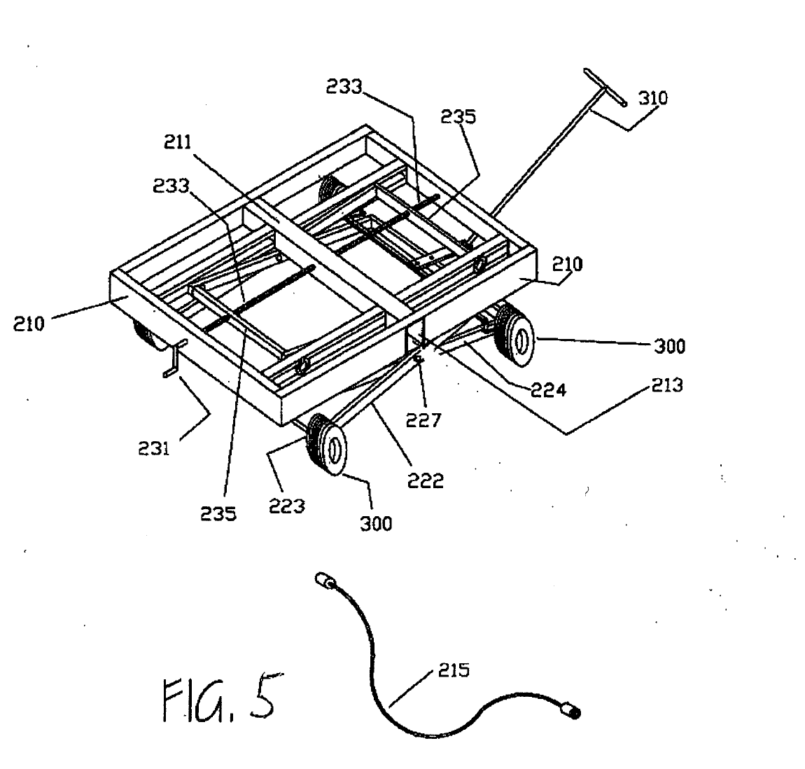

Cart 1 is constructed having a container 100 mounted on a frame 210 supporting container 100 as shown in FIGS. 4 and 5. Frame 210 and container 100 are connected to wheels 300 by an extendable base.

Container 100 and frame 210 are carried by wheels 300 and are pulled by handle 310. Wheels 300 may be connected to the steering mechanism and steered according to the direction the handle 310 is pulled.

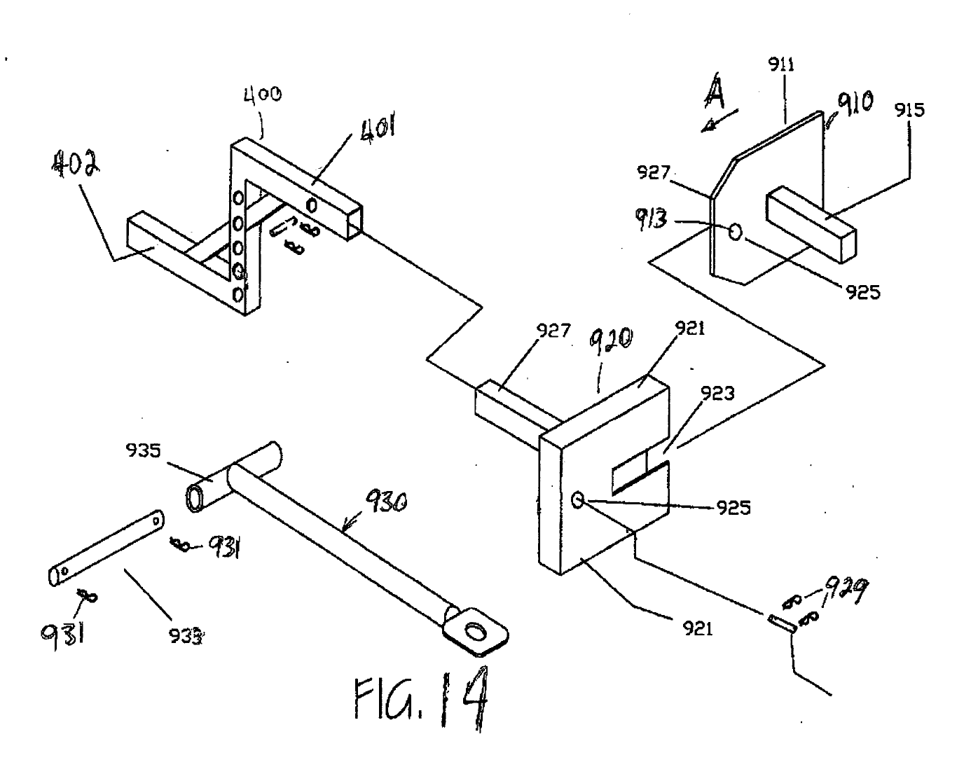

A mount bar 211 supports container 100 and frame 210 and has a receptacle 213. As shown in FIG. 1, a first end 401 of riser 400 fits in receptacle 213. Riser 400 also has a second end 402 sized and shaped to fit a vehicle trailer hitch receiver 500. First end 401 of riser 400 is designed to be significantly higher than second end 402. This causes container 100, frame 210, and wheels 300 to be carried higher than the vehicle trailer hitch allowing cart 1 to be carried by a vehicle without hitting the ground. Riser 400 is also shown in FIG. 14.

A power cord 215 of FIG. 2 is designed to plug into the vehicle and receive power for lights 151 and other equipment. An outer side wall has brake, reverse and turn signal lights 151 shown in FIG. 3.

Container 100 may be embodied in different ways, having different structures to meet its intended uses. For example, in FIGS. 2 and 3, cart 1 may have a rear door 111 in its rear wall 110 attached by hinges 115 and held closed by a latch 117. Similarly, a side wall 120 may have one or more doors 121 attached by hinges 125 held closed by a latch 123. Latches 117 and 123 may be designed to be locked with a key, combination, or other method to restrict access.

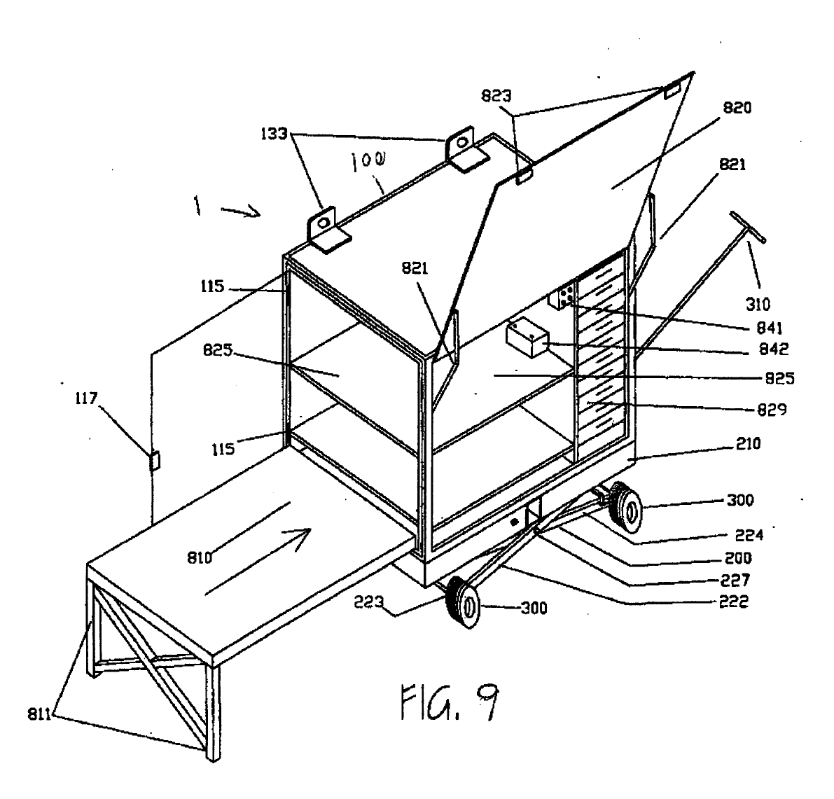

Any power required by cart 1 may be provided by internal batteries, such as batteries 842 shown in FIG. 9 which will be discussed later. Batteries 842 may be charged when cart 1 is in storage or by vehicle 3 as it is being transported.

In FIG. 1, container 100 may employ hooks 131 in roof 130. Straps 133 connect to hooks 131 and to a stable portion of the carrying vehicle to stabilize cart 1. Straps 133 may have attachment devices at the vehicle end to attach to the underside of the bumper of vehicle 3. They also may attach to the lip of the vehicle's rear hatch as is common with bicycle carriers.

Cart 1 may be constructed of weatherproof materials and have weatherproof seals on any of its external doors 111, 121. Therefore it may be carried and used in inclement weather. In addition to being weatherproofed, cart 1 may employ a number of wall mounts 133 on roof 130, allowing cart 1 to be bolted to an appropriately modified external wall of a building when not in use. This thereby allows cart 1 to double as a storage facility.

Since vehicles carry a significant amount of weight on their trailer receiver 500, cart 1 may have a significantly large size and capacity. It would therefore be difficult for an individual user to mount cart 1 on a vehicle. Therefore, cart 1 employs an extendable base 200. One embodiment of an extendable base consistent with the present invention is shown in FIGS. 4 and 5. In FIG. 4 the extendable base 200 is shown in its partially elevated position. In FIG. 5, the extendable base 200 is shown in its lowered position.

Extendible base 200 employs in FIGS. 4 and 5 an elevation device 230 which functions to raise mount bar 211 and mount receptacle 213 of cart 1 to a proper height to mount onto first end 401 of riser 400. In the alternative, a level bar may fit in mount receptacle 213 of cart 1 and directly fit into vehicle receiver 500 (not shown).

Several different elevation devices exist to raise mount receptacle 213 to the proper height which may include screw-type jacks, pneumatic lifts, hydraulic lifts, or other extendible lifts. The type shown in FIGS. 4 and 5 is a scissors-type lift having legs which are extended by a manual mechanical screw 237.

A leg 222 is designed to attach between a first wheel 300 and a retractable bar 233 in a diagonal inclined position. Similarly, a second leg 224 attaches between a second wheel 300, and a screw anchor 235. Legs 222 and 224 cross and are attached at a straight, mid-section of each leg at a leg pivot point 227. Legs may alternatively have a curved section 223 at the wheel end of leg 222. This curved section 223 allows the wheels to further tuck into extendable base 200 when retracted.

As handle 231 is cranked, screw 237 turns pulling screw anchor 235 closer to retractable bar 233. This causes screw anchor 235 and/or retractable bar 233 to move along frame 210. This causes legs 222 and 224 to pivot about leg pivot point 227 and extend downward, raising container 100, frame 210 and mount receptacle 213. The extendable base 200 now allows a single person to easily and accurately raise the cart to the proper height for removal from the vehicle, or attachment to the vehicle.

In an alternative embodiment, the rear wheels 300 are mounted on pivots as shown in FIG. 2 as pivot wheel 305. They are held in straight alignment pointing front to back of cart 1 by a pin or other means. When the pin is removed or other securing means is released, the rear wheels 300 are allowed to pivot. With the front wheels 300 turned sideways, and the rear wheels allowed to pivot, cart 1 may be pushed sideways allowing it to be mounted on the vehicle. Also, the front wheels 300 may be on pivots also.

### Embodiments

Sports Cart

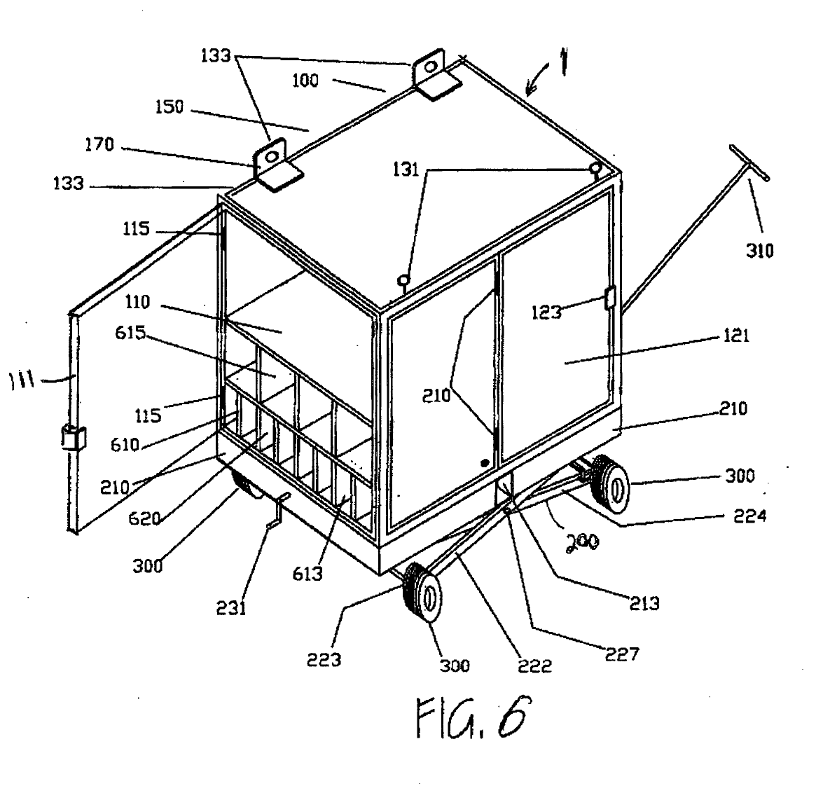

FIG. 6 shows a Sports Cart embodiment of the present invention specifically designed for softball or baseball. In this embodiment rear door 111 in rear wall opens to expose the number of shelves 610 and dividers 620 which divide the container 100 into a number of bins. The lower portion of container 100 employs more dividers 620 to divide the space into a plurality of bat bins 613 sized to receive and store baseball bats.

Fewer dividers 620 and shelves 610 are used in the section above the bat bins 613 to create a number of glove bins 615 sized to receive and store baseball gloves.

The top section may use a single shelve 610 and remain open to receive and store larger equipment.

In actual use, cart 1 is loaded with baseball gloves and bats and other related equipment that is locked and stored inside of cart 1. As stated above, cart 1 may be made to be weather-tight and employ wall mounts 133 allowing cart 1 to be bolted to an external wall of a building and create its own storage area.

Extendable base 200 may be cranked all the way down such that wheels 300 press up against the bottom of container 100. In this position, wheels 300 of cart 1 press against the bottom of container 100, acting as a brake thereby restricting movement of cart 1.

The Sports Cart embodiment is designed to hold all required sporting equipment in one place before, during and after the game. This may include pails of tennis practice balls, racquets, soccer balls, folding practice nets, ice coolers, water coolers, first aid equipment, team bats or sticks, catchers equipment, goal tenders gear, pop-up sun/rain canopy, rain gear and any necessary gear your team needs for sports.

Since the carts are closed, weatherproof and self-contained units, the equipment inside may be stored for long periods of time without becoming dirty, dusty, or weathered.

When it is time to use the equipment, cart 1 is unbolted (if bolted to a wall), crank 231 of cart 1 is turned such that wheels 300 are no longer pressing against container 100, and are allowed to rotate and be pulled to the vehicle or field.

Catering Cart

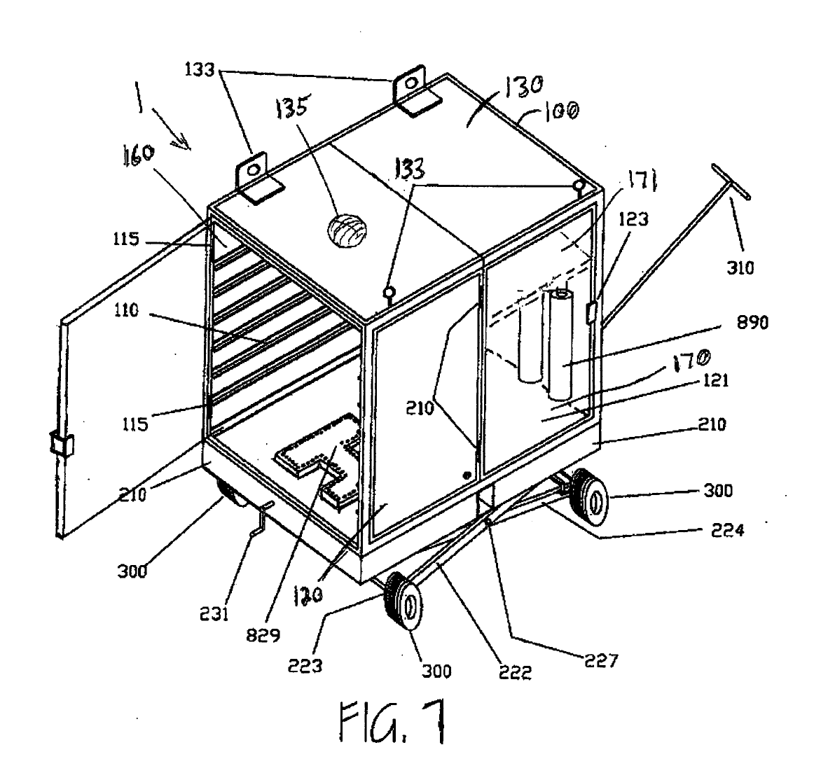

FIG. 7 is an illustration of a Catering cart embodiment of the present invention. The container 100 is specially designed to have an insulated section 160, thermally insulated sides 120, roof 130 and floor designed to keep the inside of container either hot or cold. The container 100 may include electric burners to heat the inside. The electricity will be provided by power cord 215 of FIG. 5 when mounted on the vehicle and by external power via an extension cord when rolled to the use site, such as a banquet hall. It may also employ a battery and charger system such as that shown in FIG. 9. Optionally, gas burners may be used which burn propane stored in containers 890. It may also be necessary to have a roof vent 135 to allow air circulation.

A plurality of runners 110 run down the inside of the side walls 120. These are designed to receive and hold a plurality of catering trays.

Optionally, container 100 may have a second section 170 shown in FIG. 7 which is designed for storage of supplies and equipment. This may not need to be insulated. This may include plates, silverware, serving pans, trays, napkins, etc. It may also include equipment which may be mounted on one or more internal shelves 171. This may include equipment for cutting, peeling, coring, blending or otherwise preparing food and beverages. Storage section 171 may serve as a mobile food preparation station.

In another embodiment, the front half of the cart may be split into two sections. Wherein the upper section has insulated racks that will give you room for all your cold foods. The lower section can be used for storing your dishes, silverware, bus buckets and supplies needed for the party. When the party is over, the cart may be loaded, attached to a vehicle and returned to the kitchen.

Materials Cleanup Cart

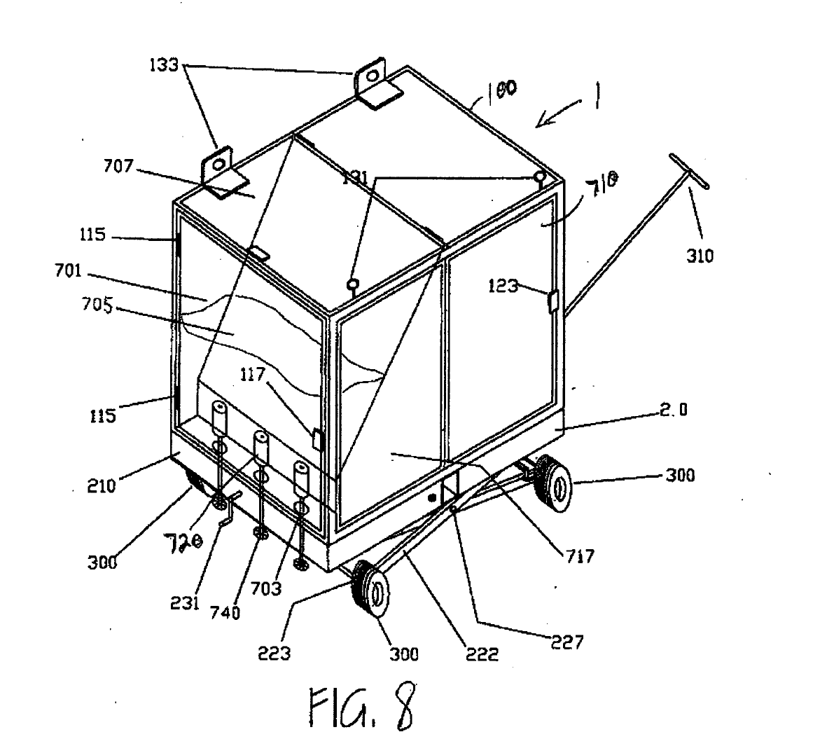

FIG. 8 shows a Materials Cleanup Cart. After there has been a materials spill, it is necessary to contain the material, transport the material to a hazardous material disposal site, and dispose of the material at the site. Extra care must be taken, especially if the material is a hazardous material. Since many material spills occur in areas which are inaccessible to larger vehicles, it is necessary to transfer the materials from one vehicle to another. Each time materials are transferred there is the possibility of additional contamination of the workers or the environment.

FIG. 8 is an illustration of a Materials Cleanup cart embodiment of the present invention intended to be used to clean up materials spills. Once the cart is unhooked from the tow vehicle 3, it becomes a mobile spreader that can be pushed right where it's needed.

It employs many of the basic features of the previous embodiments including container 100, extendable base 200, wheels 300 and handle 310. Container 100 is further adapted to be able to collect materials from spills, store the materials, transport the materials and unload the materials with minimal human contact and/or transfers of the material.

Since wheels 300 may also run over and pass through the materials, these may be made to be easily removed, stored in an appropriately sealed container, and replaced with fresh, uncontaminated wheels.

It employs a storage cabinet 710 in the front containing ‘socks’ used to contain and absorb spills.

The rear section of cart 1 employs a hopper 701 built with absorbent material 705. This absorbent material 705 falls to the bottom of the hopper and out exit ports 703. The opening of this may be adjusted by the user. After passing out of exit port 703 it may optionally fall upon one or more spreader wheels 740 driven by spreader motor 720, which spread an absorbent material 705 over the floor, thereby absorbing any remaining material on the floor. Hopper 701 is filled via a hopper door 707.

Trainer's Cart

FIG. 9 is an illustration of an embodiment of the present invention intended to be used as a trainer's cart. Since it is necessary for a sports trainer to carry athletic supplies as well as first aid kits to sporting events, a sports trainer encounters the same problems transporting their equipment and supplies as described above. Therefore, it would be desirable to manufacture mobile Trainer's Carts which may be rolled to the final usage site.

The Trainer's Cart embodiment is designed to give your athletes the on-the-spot care, during daily practice sessions. This reduces loading and unloading equipment. After use, the Trainer's Cart is intended to be pulled into the trainer's room, locked up and is ready for the next practice or game. If it is intended to be used at a remote location (away game) simply attach it to a tow vehicle (3 of FIG. 1) and drive to the game.

The container 100 of the Trainer's Cart is shown here with the extendable base 200 elevated to a countertop level. Container 100 is modified to have a sliding table 810 slide out from container 100. Sliding table 810 is used for examining an injured athlete. Sliding table 810 is supported by adjustable folding legs 811 which may be adjusted to the proper height.

Side door 820 is held in place with locks 823. When open, it is held in place by door supports 821. When open, it exposes a plurality of shelves 825 for holding medical supplies such as antiseptics, tape and gauze pads.

A shelf 825 provides an area which may be used for larger supplies, or to mount medical equipment allowing this to be used as a mobile first aid station. There are also a plurality of drawers 829 for holding medical tools such as scissors, scalpels, sutures, needles, medications, and bandages. All of these are sized to be locked into position when side door 820 is closed allowing transportation of these supplies without spilling, or disorganization.

Optionally, a tow bar 930 can be attached to cart 1 by removing handle 310. This allows one to connect cart 1 to a gold cart or an all terrain vehicle.

To provide power for equipment and light, a deep cycle 12-volt battery will run the 12-volt interior lamps, and the DC to AC power inverter provides 110 voltage. The battery is built-in and has a charging system.

Outdoor Grill

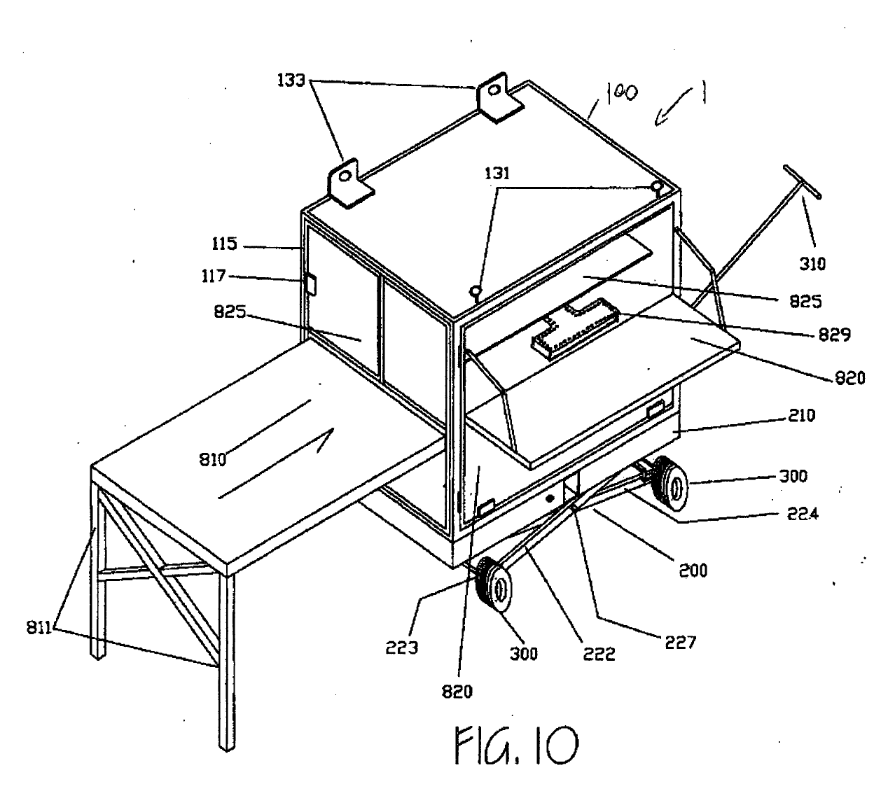

FIG. 10 shows an Outdoor Grill embodiment of the present invention employing a gas (or electric) grill 829 built into the container 100. It also includes the standard fuel hoses and valves required by a grill. Besides employing many features already described, container 100 also employs a front panel 820 which opens downward to create table space. A table 810 also slides out to create additional table space. This embodiment is well suited for tailgate parties.

Since the propane is volatile and may explode during transport, it is safe and more efficient to carry a gas grill outside according to the present invention. Also, since there is less loading and unloading, transportation is safer.

First Response Cart

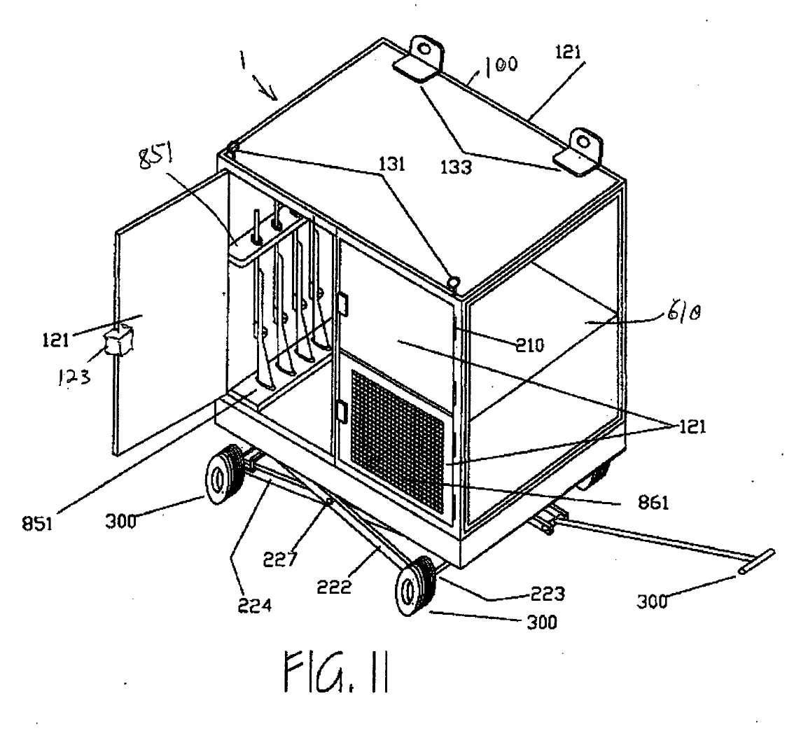

FIG. 11 shows a First Response Cart embodiment which may be designed for police, fire, and emergency personnel needing a highly mobile equipment cart. The First Response Cart is intended for small department budgets that cannot afford a stand-alone emergency vehicle to hold your special response equipment. This embodiment of the cart can be loaded and stored cost effectively. A basic first response cart employs many features already discussed including dual side doors 121 that will provide quick access to equipment. Cart 1 may employ shelves 610 on a storage side. Cart 1 employs gun racks 851 to hold assault rifles and battering rams. Cart 1 may employ test and medical equipment.

Hunting Cart

By slightly modifying the First Response cart embodiment it may result in a Hunting Cart embodiment.

By adding a vented and insulated animal carrier section 861 to the First Response cart of FIG. 11, it may be used as a Hunting cart. One can store hunting clothes in a side closet enclosed by upper door 121. Guns, ammunition and related supplies are stored safely in its gun compartment secured by lock 123. Inside, the Hunting Cart has gun racks to hold rifles and shotguns. The cart also has compartments with room for your decoys, cooler, food, water.

Again, a tow bar 930 may attached to cart 1 to pull it behind a golf cart or all terrain vehicle.

Pet Show Cart

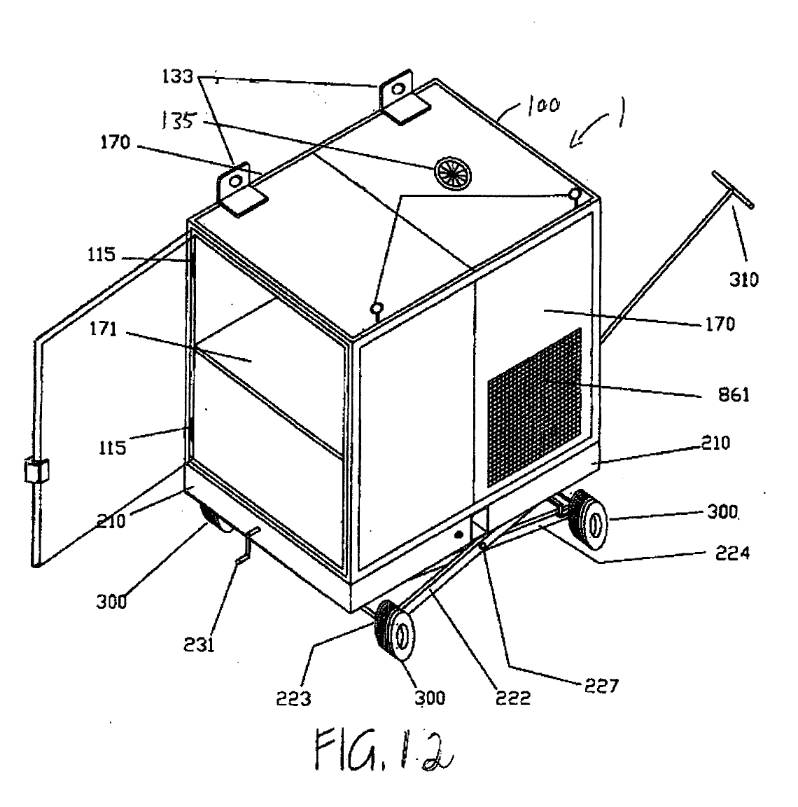

Pet shows are becoming very popular. These events may last a week or more. The Pet cart embodiment shown in FIG. 12 minimizes packing and unpacking for these shows. Cart 1 allows one to store all equipment and supplies in a single unit. The Pet Cart is attached to a vehicle, driven to the show. The cart is removed from the vehicle and pulled to where it is needed. The built-in pet compartment 170 is lockable, insulated and vented by grating 861 and roof vent 135. This will keep pets safe and secure. If it rains, everything will stay clean and dry. Once at your assigned station, the storage compartments may be opened allowing access to equipment supplies. Take out your pet and start getting him ready for the show. Optionally a slide out table similar to table 810 of FIG. 9 may be employed. After the show, everything is placed back inside the cart and locked.

The Pet Show Cart is pulled back to the tow vehicle, attached to the vehicle and driven home. When at home, the pet is removed from the Pet Show Cart, and the Pet Show Cart is used to store the equipment and supplies until the next pet show.

Trade Show Cart

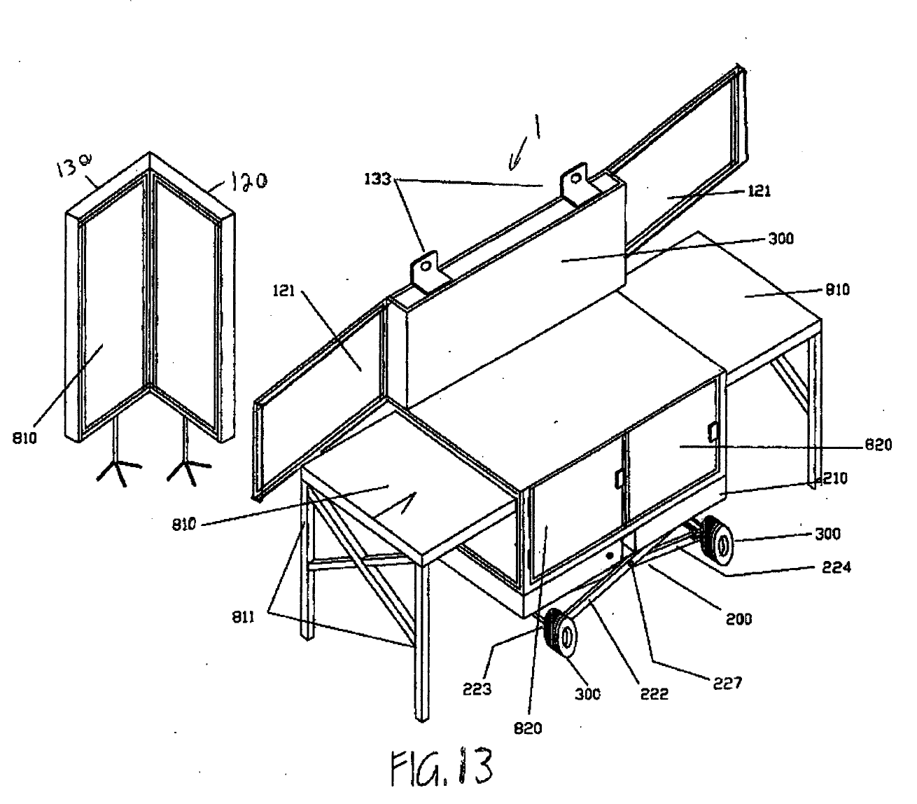

FIG. 13 shows a Trade Show Cart embodiment which provides a mobile display intended for use at a trade show. The Trade Show Cart will provide counter space with sliding tables 810, display walls 121 and storage compartments 820. Display walls 121 fold out allowing advertisements to be attached to its foam backing.

Front wall 120 and top 130 of cart 1 release to create a detachable L-shape stand-alone display 815. The height of the unit is adjustable by using its extendable base 200. Trade Show Cart 1 is movable and can be taken to other locations. When the show is over, it is designed to be closed, attached to a tow vehicle and driven home.

Other embodiments of the present invention may be employed using combinations of the features described above.

Service Company Cart

A Service Company Cart is intended to store required equipment used by those providing on-site services. A vehicle carrying the cart is driven to the company's parking lot. The wheels are cranked down and the cart is unhooked. The Service Company Cart is pulled to the job location. The cart is designed to be small enough to fit through doorways and into elevators. It may employ pivoting caster wheels such as 305 of FIG. 2, to allow the cart to move easily around tight offices. The cart also has a built-in storage cabinet for parts. Roof 130 is made out of stainless steel, so it can be used as a workbench. Optionally it may employ a vise and other equipment removably attached to the shelves. This embodiment is a complete mobile unit that will increase the service technician's productivity.

Construction Cart

Construction Carts are specially designed for carpenters, plumbers, electricians and all types of construction workers who have to move their equipment from room to room, floor to floor or even building to building. These are intended to be used at construction sites, maintenance shops servicing multiple buildings, estates with multiple buildings. In this embodiment, the tires are solid so the tires will not be flattened by nails and other debris common on the construction site. It preferably employs four corner eyebolts on the roof such as 131 as shown in FIGS. 1 and 2, which allows this cart to be lifted by a crane to its work site. An optional slide-out workbench similar to that of previous embodiments is useful in cutting wood or as a table to examine blueprints. It may also employ a removable vice.

Camping Cart

A Camping Cart embodiment is intended to store camping equipment. During use, it keeps the gear and supplies dry and protects food from animals. The slide-out table serves to provide cooking space or may act as a flat utility surface. The top cabinets are designed to hold water jugs and coolers.

Armored Cart

In another alternative embodiment, cart 1 may be armored and used as a mobile ammunition supply cart. This would be effective since there would be less danger to the occupants of the vehicle carrying the ammunition since it would be outside of the vehicle. Also, since the present invention minimizes loading and unloading, it is a safer way of transporting ammunition.

The structure would have a structure similar to the baseball cart described above, except having bins sized to receive ammunition shells, and extensive outer armor.

In FIG. 14 shows an optional device for securing cart 1 to a vehicle. It has a cart extension 910 intended to be secured to cart 1 and a vehicle extension 920 intended to be secured to the vehicle. A vehicle bar 927 is shaped and sized to securely fit into a trailer receiver 500 of (FIG. 1) on a vehicle. Vehicle extension 920 also has a U-shaped carrier 921. U-shaped carrier 921 has an open inside section and a horizontal opening 923.

The cart extension 910 has a cart bar 915 sized and shaped to fit into mount receptacle 211 of FIGS. 4 and 5 of cart 1. It also has a horizontal plate 911 sized and shaped to fit snugly into U-shaped carrier 921. Plate 911 is intended to move in the direction marked by arrow “A” to be received by U-shaped carrier 921. Once in place, plate 911 is secured by a pin 927 which passed through U-shaped carrier 921, via pin holes 925, and plate 911 via pin hole 913. Clips 929 hold pin 927 in place. The function of vehicle extension 920 and cart extension 910 is to allow cart 1 to move in a horizontal direction with respect to the vehicle, which is forward or backward on the cart's wheels to attach to the vehicle.

Without this type of connection, cart 1 and riser 400 are aligned with the receiver of the vehicle. The vehicle must then be backed into cart 1 to attach cart 1 to the vehicle. This usually requires a second person to direct the driver. Using vehicle extension 920 and cart extension 910, a single person may align and attach cart 1 to the vehicle.

Any embodiment of cart 1 described above may be used with a quick release tow bar 930 shown in FIG. 14, Tow bar 930 employs a tubular section 933 which attaches to cart 1. A bar section 935 fits over tubular section 930 and is held in place with pins 931. A loop 933 of bar 930 attaches to a golf cart or all terrain vehicle allowing cart 1 to be pulled to locations that are far from a road or parking lot.

It should be understood that even though features were discussed in connection with a specific embodiment, any or all of these embodiments may employ any of these features and still remain within the scope of the present invention.

Having thus described the invention, what is desired to be protected by Letters Patent is presented in the appended claims.

What is claimed is:

1. A portable cart designed for attachment to a vehicle having a trailer hitch with a receiver, comprising:
a) a container having a mount side wall, an outer side wall, a front wall, a rear wall, roof and a floor;
b) at least two wheels;
c) an extendable base connecting the wheels to the container and for supporting the container at a plurality of adjustable heights; and
d) a mount bar connected to the portable cart designed to be received by said receiver of said vehicle's trailer hitch thereby supporting and carrying the portable cart.

2. The portable cart of claim 1, wherein the mount bar is attached to the container.

3. The portable cart of claim 1, wherein the mount bar is attached to the extendable base.

4. The portable cart of claim 1, further comprising a rigid frame supporting the container and connected to the extendable base.

5. The portable cart of claim 1 further comprising brake lights on its outer side wall and a power cord for supplying power to the brake lights when attached to the vehicle.

6. The portable cart of claim 1 further comprising thermal insulation to resist heat transfer through the container.

7. The portable cart of claim 1 further comprising a heat source for heating the inside of the container.

8. The portable cart of claim 1 further comprising a cooling source for keeping the inside of the container cold.

9. The portable cart of claim 1 further comprising a table which slides out of the container.

10. The portable cart of claim 1 further comprising a hopper and spreader for spreading material on the ground.

11. The portable cart of claim 1 further comprising a plurality of bins sized and shaped to store sporting equipment.

12. The portable cart of claim 1 wherein the walls, roof and floor are constructed of armor.

13. The portable cart of claim 1 wherein the extendable base comprises:
a scissors-type lift for adjustably raising the container to a desired height.

14. The portable cart of claim 1 wherein the extendable base comprises:
a hydraulic lift for adjustably raising the container to a desired height.

15. The portable cart of claim 1 wherein the extendable base comprises:
a pneumatic lift for adjustably raising the container to a desired height.

16. The portable cart of claim 1 further comprising an outdoor grill.

17. The portable cart of claim 1 further comprising a gun rack.

18. The portable cart of claim 1 further comprising a compartment having a ventilated door for accommodating the transport of animals.

19. The portable cart of claim 1 wherein the front wall and the roof are removable and transform into a stand-alone display

20. The portable cart of claim 1 wherein the side walls fold out to create a display surface.

21. A method of transporting cargo to a user site, comprising the steps of:
a) providing a mobile cart having a container and wheels, and a mount bar, the cart being capable of being wheeled, the cart also having an extendable base capable of lifting the mount bar to a plurality of heights;
b) providing a vehicle for transporting the mobile cart, having a trailer hitch;
c) extending the base to allow the mount bar to be supported by the vehicle's trailer hitch;
d) connecting the mount bar to trailer hitch of the vehicle;
e) retracting the extendable base so as to retract the wheels;
f) driving the vehicle carrying the cart to a desired user site.

22. The method of claim 21 wherein the step of connecting the mount bar to the trailer hitch comprises the steps of:
a) connecting a riser to the vehicle trailer hitch; and
b) connecting the mount bar to the riser.

23. The method of claim 21 wherein the step of connecting the mount bar to the trailer hitch comprises the steps of:
a) connecting a vehicle extension having a horizontal opening to the vehicle;
b) connecting a cart extension to the cart having a horizontal plate sized and shaped to slide horizontally into the vehicle extension;
c) moving the cart such that the horizontal plate slides horizontally into the vehicle extension and is secured by the vehicle extension.

24. The method of claim 21 further comprising the steps of
a) extending the extendable base so that the wheels support the weight of the portable cart;
b) removing the cart from the vehicle; and
c) wheeling the cart to the user site.
